(19) United States
(12) Patent Application Publication
(10) Pub. No.: US 2006/0081388 A1
(43) Pub. Date: Apr. 20, 2006

(54) Flexible power cable

(76) Inventor: Bernfried Spath, Langenfeld (DE)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/107,366

(22) Filed: Apr. 15, 2005

(30) Foreign Application Priority Data
Oct. 18, 2004 (DE) 20 2004 016 182.6

(51) Int. Cl. H01B 11/00

(52) U.S. Cl. 174/27

(57) ABSTRACT

A flexible power cable with a core assembly (2) and a sheath (3) encasing the core assembly, where the core assembly (2) has at least four conductors (4), each conductor comprising a litz wire (5) or a cord, which is provided with insulation (6), is characterized in that the core assembly (2) comprises conductors (4) woven together to form a braided structure, in order to ensure stable positioning of the conductors when subjected to high numbers of bending stress cycles.

The invention relates to a flexible power cable with a core assembly and a sheath encasing the core assembly, where the core assembly has at least four conductors, each conductor comprising a litz wire or a cord, which is provided with insulation.

Power cables of this kind are used frequently in engineering. They are subjected to high mechanical stresses, particularly when they serve to connect a mobile device to a stationary energy supply, for example. For this reason, power cables are protected inside energy chains and the like. While this reduces external stresses acting on the power cable, mechanical stresses continue to act, particularly bending and tensile stresses, to which the power cable is exposed when the device travels. It has been observed in this context that the core assemblies in conventional power cables expand when exposed to high number of stress cycles, even if the conductors in the core assembly are twisted. In the process, the conductors can twist or curl into a corkscrew-like position, and thereby at the very least impair proper travel motion. Conductor and sheath ruptures can occur as a result, which are caused by friction between the conductor and the sheath or within the core assembly, by the kinking of the conductors with embrittlement phenomena in the conductor material, etc.

The object of the invention is therefore to provide an elastic power cable of the type described in the opening paragraph, in which the conductors are positioned more stably relative to one another when exposed to high numbers of bending stress cycles.

According to the invention, the object is solved in that the core assembly of a flexible power cable of the type described in the opening paragraph comprises conductors woven together to form a braided structure. As a result of this braided structure, the interwoven conductors can be fixed in position more stably. The braided structure permits the individual conductors to move slightly relative to one another, thus ensuring the required flexibility of the braided structure or power cable.

In this context, a braided structure is preferred in which the conductors run at an angle to one another, where one conductor is alternately fed under and over the conductors crossing it. Naturally, other weave patterns are conceivable, for example in that one conductor runs over and under two conductors that cross it. In this case, the conductors can be positioned in relation to the longitudinal axis of the core assembly such that some of the conductors run in the longitudinal direction of the core assembly, while the others run in a helical line around the longitudinal axis of the core assembly and are woven around the other conductors. The conductors running in the longitudinal direction of the core assembly can simultaneously be designed to absorb tensile forces, in which case they preferably have a larger cross-section than the conductors running in a helical line. Furthermore, additional conductors can run in a third direction, in the opposite helical orientation around the longitudinal axis of the core assembly, and be woven together with the other conductors.

In a preferred embodiment of the invention, the braided structure is formed by conductors twisted in the right-hand and left-hand direction around the longitudinal center axis of the core assembly. As a result, rotational moments, particularly torsional moments, acting on the core assembly or the braided structure, are absorbed or compensated for by the conductors such that curling into a corkscrew structure is prevented.

In a further development, the braided structure is of tubular design. This structure is particularly advantageous when multiple conductors are involved, which are then woven more stably into a strand and thus held in position more stably relative to one another.

In another development, the core assembly has a core element running along its center axis, around which the braided structure is positioned. This achieves further stabilization of the core assembly. The core element can preferably be designed as an element capable of absorbing tensile forces. Furthermore, the core element can be a strand sheathed in a foamed material. In this case, it is advantageous for the braided structure to be woven around the core element so that the braided structure can be embedded in the foamed material and thus fixed more stably in position. Alternatively, the core element can be a cord made of plastic with high tensile strength.

As described above, the conductors can be arranged in a simple braided structure in the core assembly. However, it is also conceivable for the conductors to be arranged in a complex braided structure, particularly a double-braided structure. In this case, the double-braided structure is preferably coaxial, having an inner and an outer braided structure. A friction-reducing layer of plastic nonwoven fabric or talcum can be provided between the two braided structures. The arrangement of the conductors in a double-braided structure further stabilizes the position of the interwoven conductors.

In a further development of the power cable, the braided structure has a length of lay that is less than 8 times the conductor diameter multiplied by the number of conductors.

Preferably, the length of lay can be less than 6 times the conductor diameter multiplied by the number of conductors. Particularly preferably, the length of lay can be less than 4 times the conductor diameter multiplied by the number of conductors. In this context, the length of lay is understood to be the length after which a conductor returns to the same position on the strand in which it started, referred to the cross-section. The shorter the length of lay, the stronger the braided structure and the more stably the conductors are fixed in position within the braided structure.

One parameter influencing the optimum length of lay is the diameter of the woven conductors. Although it is initially assumed here that the conductors have equal diameters, the scope of the invention is not restricted to this characteristic, but rather likewise encompasses conductors with different diameters.

The conductors can have a cross-section of roughly 0.5 mm² to roughly 185 mm², preferably a cross-section of roughly 1.0 mm² to roughly 30 mm² and particularly preferably a cross-section of roughly 1.5 mm² to 50 mm². In this context, it must be expected that conductors with a large cross-section are more difficult to braid than conductors with a small cross-section, although they can be fixed in position more stably in the braided structure.

In a further development of the object according to the invention, the insulation can be made of a material with a hardness of Shore D30 to D90, preferably with a hardness of Shore D35 to D80, and particularly preferably with a hardness of Shore D40 to D75. As a result, the insulation displays sufficient hardness to withstand external stresses, without simultaneously being too brittle to bend effectively and thus tending towards flexural brittleness.

The insulation can have a wall thickness of roughly 0.5 mm to 3.0 mm, preferably a wall thickness of 0.5 mm to 2.5 mm, and particularly preferably a wall thickness of 0.5 mm to 2.0 mm. As a result, the insulation has a sufficiently large wall thickness to adequately protect the conductors even when exposed to fairly high mechanical stress.

The insulation can be made of an abrasion-resistant and durable plastic. As described above, the individual conductors in the braided structure can move slightly relative to one another, which can result in abrasion of the insulation of the conductors. Therefore, abrasion-resistant insulation is advantageous, and preferably made of plastic. The plastic is preferably a polyvinyl chloride, polyurethane, polyester or some other thermoplastic elastomer.

In an advantageous development of the power cable, the sheath lies loosely on the core assembly and is thus manufactured particularly in the manner of a tube. Consequently, torsional forces acting especially on the sheath in a specific area are only transmitted to the core assembly inside the sheath to a minor degree, meaning that the core assembly, as well as the conductors located therein, can be fixed in position more stably. The sheath material is preferably a thermoplastic elastomer, which is preferably notch-resistant, and particularly preferably scrub-resistant in order to be suitably flexible and also display sufficient strength for resisting sheath ruptures. Furthermore, the sheath can be made of an ageing-resistant, embrittlement-resistant plastic or rubber.

In a further development of the power cable, a filler can be provided between the sheath and the core assembly. Preferably, a filler is also provided between the woven conductors. In both cases, the filler serves to transmit external stresses across the cross-section, from the sheath to the core assembly, and to the conductors. Talcum is preferred as a filler in this context. The talcum, which is preferably a powder, permits slight shifting and simultaneously acts as a friction-reducing material between the rubbing surfaces of the sheath, the core assembly, and the conductors.

Alternatively, a plastic-can be provided as the filler, which is extruded under pressure around the woven conductors. In this context, the conductors are fixed in a stable position by the plastic and can thus shift less relative to one another.

Furthermore, a preferred embodiment of the flexible power cable is proposed, in which the sheath displays an inner sheath and an outer sheath, where the inner sheath lies against the outer sheath in sliding fashion. In this way, any torsional forces are transmitted only to a slight degree from the inner sheath to the outer sheath.

In a further development, a woven material can be provided between the inner sheath and the outer sheath such that the inner sheath is protected more extensively, as a result of which any torsional forces are transmitted to an even lesser degree, and the conductors can be held in a more stable position relative to one another. Alternatively, a friction-reducing filler can be provided, such as talcum or a plastic nonwoven fabric. The filler can be provided in the intermediate space between the inner sheath and the woven material or plastic, and/or between the outer sheath and the woven material or plastic.

Preferably, the inner sheath is made of a flexible foam. In a further development of the power cable, the foam can tightly encase the core assembly and thus contribute to further stabilizing the position of the core assembly and the conductors. In this context, the outer sheath can preferably be made of a notch-resistant and scrub-resistant material.

In a preferred embodiment, the flexible power cable further displays one cable comprising several core assemblies in accordance with one of the embodiments already described, where it is furthermore preferable for the core assemblies to be woven into a braided structure. As a result, the core assemblies are fixed in position more stably relative to one another in the power cable than if they did not have a braided structure. In this context, the intermediate spaces between the woven core assemblies can be provided with a filler, such as talcum. Furthermore, a plastic sheath can be provided around the woven core assemblies.

Several practical examples of the invention are described below in greater detail on the basis of an associated drawing. The drawing shows the following:

FIG. 1 A perspective side view of a power cable with partially exposed core assembly,

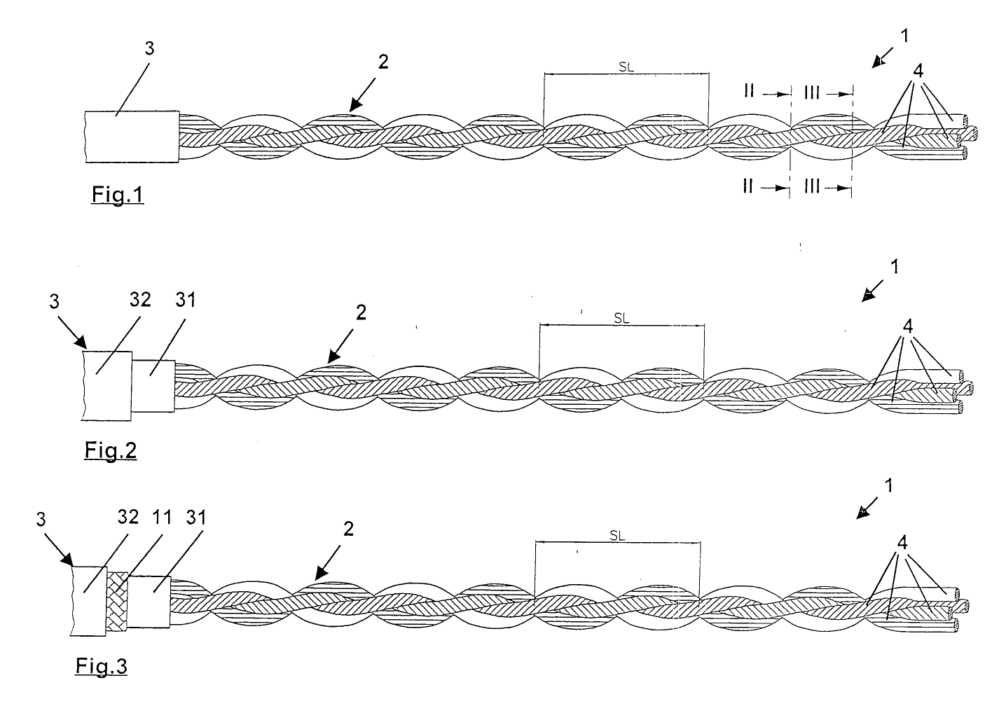

FIG. 2 A perspective side view of the power cable according to FIG. 1, but with an inner sheath and outer sheath,

FIG. 3 A perspective side view of the power cable according to FIG. 2, but with additional woven material,

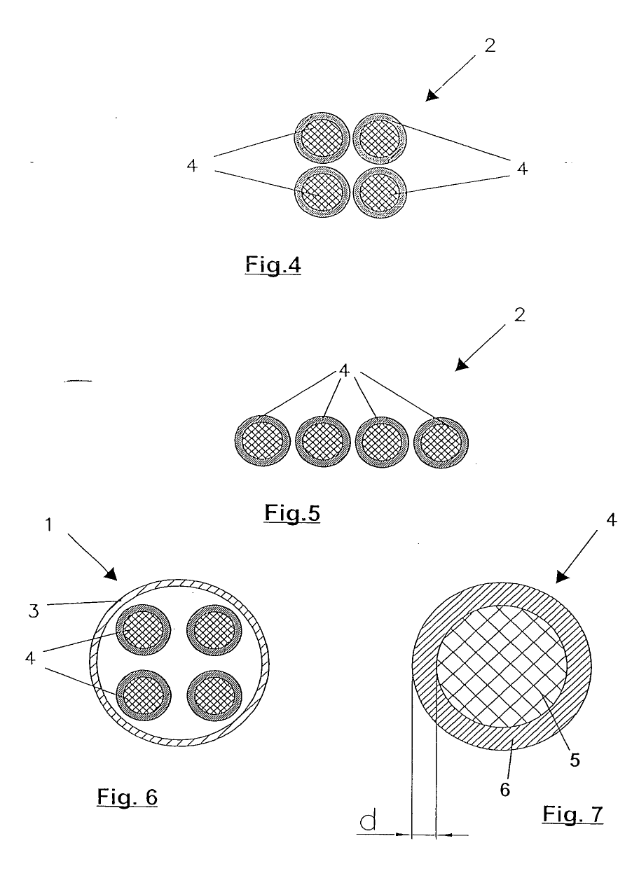

FIG. 4 A cross-sectional view along Line II-II in FIG. 1,

FIG. 5 A cross-sectional view along Line III-III in FIG. 1,

FIG. 6 A cross-sectional view of the power cable according to FIG. 1, with sheath,

FIG. 7 A cross-sectional view of a single conductor,

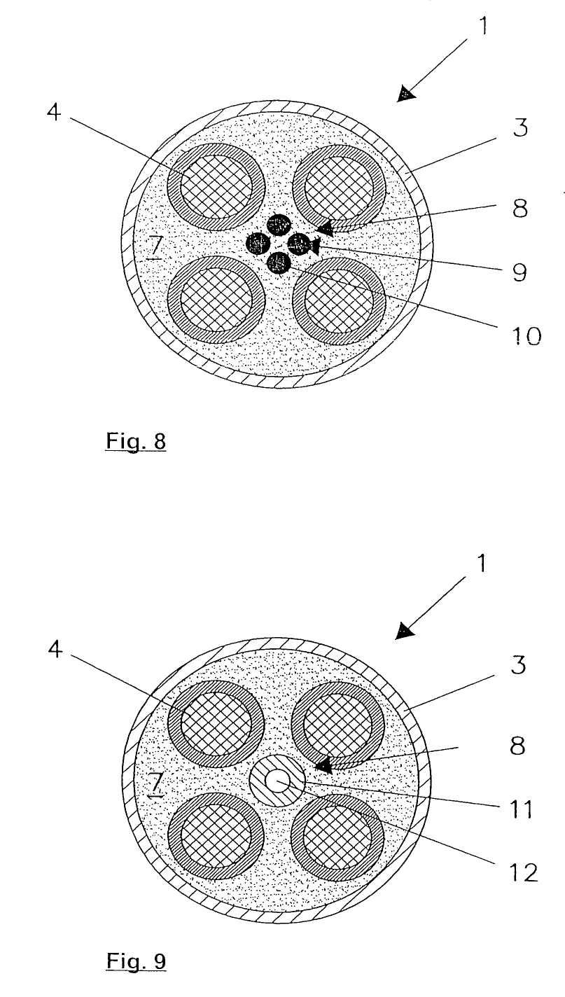

FIG. 8 A cross-sectional view of the power cable according to FIG. 2, but with an additional core element,

FIG. 9 A cross-sectional view of the power cable according to FIG. 8, but with a different additional core element,

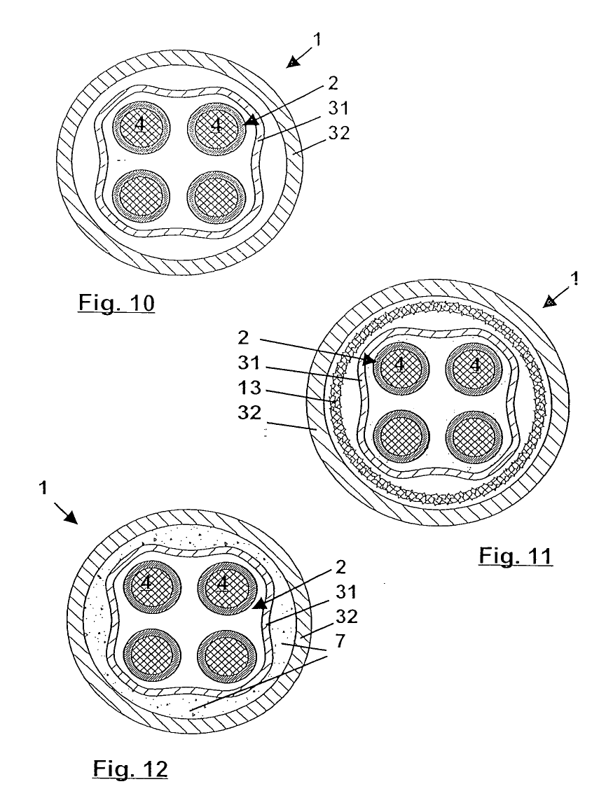

FIG. 10 A cross-sectional view of the power cable with sheath according to FIG. 2,

FIG. 11 A cross-sectional view of the power cable with sheath according to FIG. 3,

FIG. 12 A cross-sectional view of the power cable according to FIG. 2 and FIG. 10, but with filler between the inner sheath and outer sheath,

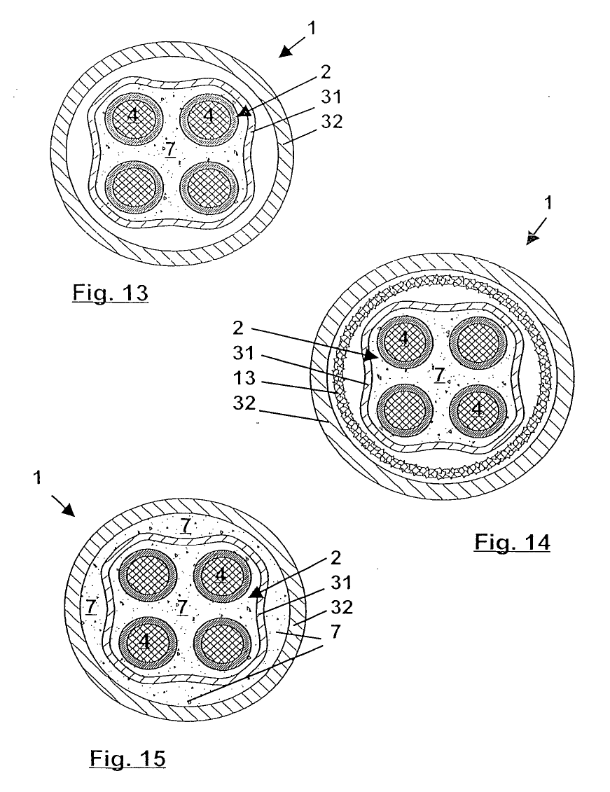

FIG. 13 A cross-sectional view of the power cable according to FIG. 2 and FIG. 10, but with additional filler in the interior space enclosed by the inner sheath,

FIG. 14 A cross-sectional view of the power cable according to FIG. 3 and FIG. 11, but with filler in the interior space enclosed by the inner sheath, and

FIG. 15 A cross-sectional view of the power cable according to FIG. 13, but with filler between the inner sheath and outer sheath.

FIGS. 1 to 6, and 8 to 15 show various embodiments of flexible power cable 1. Flexible power cable 1 is provided with a core assembly 2, and a sheath 3 encasing core assembly 2, where core assembly 2 has four conductors 4.

FIGS. 1 to 3 show three different embodiments of the power cable, where for the purpose of better illustration, sheath 3 has been cut away leaving just a short section appearing at the left of each Figure. As these Figures show particularly clearly, core assembly 2 comprises four conductors 4, woven into a braided structure. In this context, the braided structure is formed by right-handed and left-handed conductors 4 around the longitudinal center axis of core assembly 2. The braided structure has a length of lay SL, where the length of lay SL is understood to be the length after which a conductor 4 returns to the same position on core assembly 2 in which it started, referred to the cross-section. The strength of the braided structure can be influenced by the length of lay SL, i.e. the shorter the length of lay SL, the stronger the braided structure and the more stably conductors 4 are fixed in position within the braided structure. In the example shown here, length of lay SL is equal to roughly eight times the diameter of conductor 4 multiplied by the number of conductors 4 (i.e. by 4). FIGS. 1 to 3 further show the successive coaxial design of the three embodiments illustrated, based on the section of the power cable appearing at the left of each Figure. This is addressed in greater detail in the description.

The relative position of conductors 4 is illustrated in greater detail in FIGS. 4 and 5, based on cross-sections II and III according to FIG. 1. The two cross-sectional diagrams define two specific positions of conductors 4 relative to one another, where the relative positions of conductors 4 alternate continuously between these specific positions over the length of core assembly 2, meaning that, in this embodiment, conductors 4 assume the two specific positions four times within one length of lay SL. As the cross-sectional diagrams further show, conductors 4 are designed not to be directly in contact with one another, meaning that they display a degree of play relative to one another, which allows them to shift their relative position over a specific, short distance, thus increasing the flexibility of the power cable.

FIG. 6 shows a cross-sectional view of the power cable according to FIG. 1 (a section from the left in FIG. 1), where sheath 3 has not been cut away in order to better illustrate the braided structure. It can be seen that sheath 3 is loose on core assembly 2 and encases it, so that torsional forces acting from the outside can only be transmitted from sheath 3 to core assembly 2 to a minor degree, if at all, thus increasing the flexibility of power cable 1. In an embodiment of the flexible power cable not shown here, the braided structure can also be of tubular design, which likewise increases the flexibility of the power cable.

As shown particularly clearly in the cross-sectional view of a single conductor 4 in FIG. 7, each conductor 4 comprises a litz wire 5 or a cord, which is provided with insulation 6. Conductors 4 can have a cross-section of roughly 0.5 mm² to roughly 185 mm², preferably a cross-section of roughly 1.0 mm² to roughly 30 mm², or a cross-section of roughly 1.5 mm² to 50 mm². Insulation 6 can have a thickness d (shown in FIG. 7) of roughly 0.5 mm to 3.0 mm, preferably roughly 0.5 mm to 2.5 mm, or particularly preferably 0.5 mm to 2.0 mm. The hardness of the insulation can be Shore D30 to D90, preferably D35 to D80, or particularly preferably D40 to D75.

Sheath 3 and insulation 6 are made of an abrasion-resistant and ageing-resistant plastic, particularly polyvinyl chloride, polyurethane, polyester or some other thermoplastic elastomer.

In the embodiments of power cable 1 shown in FIGS. 8 and 9, sheath 3 and core assembly 2 are separated by filler 7, which is also incorporated between woven conductors 4. In this context, filler 7 can be talcum or a plastic, for example, where the plastic, together with sheath 3, can be extruded under pressure around woven conductors 4. As indicated by the dotted area in the cross-sectional diagram, the talcum in this embodiment is a powder, the particles of which can slide relative to one another, but nevertheless stably hold the elements adjacent to them firmly in place relative to one another.

The embodiments of flexible power cable 1 shown in FIGS. 8 and 9 additionally have a core element 8, running essentially along the central longitudinal axis, around which the braided structure is positioned. Core element 8 shown in FIG. 8 comprises cord 9 with interwoven cord fibers 10, preferably made of a strong plastic. Core element 8 in the embodiment of flexible power cable 1 shown in FIG. 9 has a strand 12, sheathed in foamed material 11. In the embodiment shown here, the braided conductor structure is loosely embedded around core element 8. However, it can also be flexibly embedded, at least partially, in the foamed material, such that it can slide to a slight degree, meaning that it can be fixed more stably in position.

FIGS. 10 to 15 show various embodiments of power cable 1, whose sheath 3 displays inner sheath 31 and outer sheath 32. In these cases, outer sheath 32 is positioned loosely and in sliding fashion relative to inner sheath 31, and inner sheath 31 is positioned loosely and in sliding fashion relative to conductors 4. As a result, forces transmitted into outer sheath 32 can only be transmitted to a slight degree to inner sheath 31, and to an even lesser degree from inner sheath 31 to conductors 4. The space between conductors 4 is intended to schematically illustrate once again the mobility of conductors 4 relative to one another, which at least impedes the transmission of forces between conductors 4. Furthermore, each of the three arrangements described contributes to increasing the flexibility of power cable 1.

FIG. 11 shows an embodiment of power cable 1, in which tubular woven material 13 is located between inner sheath 31 and outer sheath 32. Woven material 13 forms another protective barrier between inner sheath 31 and outer sheath 32. Thanks to its woven structure, it can absorb weak deformation forces without transmitting them to inner sheath 31.

FIG. 12 shows another embodiment of the invention, in which filler 7 is provided in the intermediate space between inner sheath 31 and outer sheath 32, such that inner sheath 31 and outer sheath 32 are fixed more stably in position relative to one another. Talcum is again the preferred filler in this case.

Much as in FIGS. 8 and 9, filler 7 in FIG. 13 is located inside inner sheath 31 and between conductors 4, such that conductors 4 and inner sheath 31 are fixed stably in position relative to one another.

As an addition to the example shown in FIG. 13, the embodiment of the invention illustrated in FIG. 14 shows woven material 13 provided between inner sheath 31 and outer sheath 32, said woven material 13 serving as protection and to absorb deformation forces.

In the embodiment shown in FIG. 15, filler 7 fills all intermediate spaces between conductors 4, inner sheath 31 and outer sheath 32, thus ensuring corresponding positional stability of conductors 4, inner sheath 31 and outer sheath 32 relative to one another. Furthermore, but not shown here, the woven material can be provided between the inner sheath and the outer sheath.

### LIST OF REFERENCE NUMBERS

1 Power cable
2 Core assembly
3 Sheath
4 Conductor
5 Litz wire
6 Insulation
7 Filler
8 Core element
9 Cord
10 Cord fiber
11 Material
12 Strand
13 Woven material
31 Inner sheath
32 Outer sheath
SL Length of lay

1. Flexible power cable with a core assembly and a sheath encasing the core assembly, where the core assembly has at least four conductors, each conductor comprising a litz wire or a cord, which is provided with insulations, characterized in that the core assembly comprises conductors woven together to form a braided structure.

2. Flexible power cable according to claim 1, characterized in that the braided structure is formed by right-handed and left-handed conductors around the longitudinal center axis of the core assembly.

3. Flexible power cable according to claim 1, characterized in that the braided structure is of tubular design.

4. Flexible power cable according to one claim 1, characterized in that the core assembly has a core element running along its center axis, around which the braided structure is positioned.

5. Flexible power cable according to claim 4, characterized in that the core elements is a strand sheathed in a foamed material.

6. Flexible power cable according to claim 4, characterized in that the core element is a cord made of plastic with high tensile strength.

7. Flexible power cable according to claim 1, characterized in that the braided structure has a length of lay that is less than 8 times the conductor diameter multiplied by the number of conductors.

8. Flexible power cable according to claim 1, characterized in that the braided structure has a length of lays that is less than 6 times the conductor diameter multiplied by the number of conductors.

9. Flexible power cable according to claim 1, characterized in that the braided structure has a length of lay that is less than 4 times the conductor diameter multiplied by the number of conductors.

10. Flexible power cable according to claim 1, characterized in that the conductors have a cross-section of roughly 0.5 mm² to roughly 185 mm².

11. Flexible power cable according to claim 1, characterized in that the conductors have a cross-section of roughly 1.0 mm² to roughly 30 mm².

12. Flexible power cable according to claim 1, characterized in that the conductors have a cross-section of roughly 1.5 mm² to roughly 50 mm².

13. Flexible power cable according to claim 1, characterized in that the insulations is made of a material with a hardness of Shore D30 to D90.

14. Flexible power cable according to claim 1, characterized in that the insulations is made of a material with a hardness of Shore D35 to D80.

15. Flexible power cable according to claim 1, characterized in that the insulations is made of a material with a hardness of Shore D40 to D75.

16. Flexible power cable according to claim 1, characterized in that the insulations has a wall thickness of roughly 0.5 mm to 3.0 mm.

17. Flexible power cable according to claim 1, characterized in that the insulation has a wall thickness of roughly 0.5 mm to 2.5 mm.

18. Flexible power cable according to claim 1, characterized in that the insulation has a wall thickness of roughly 0.5 mm to 2.0 mm.

19. Flexible power cable according to claim 1, characterized in that the insulation and the sheath are made of an abrasion-resistant and ageing-resistant plastic.

20. Flexible power cable according to claim 19, characterized in that the plastic is polyvinyl chloride, polyurethane, polyester or some other thermoplastic elastomer.

21. Flexible power cable according to claim 1, characterized in that the sheath lies loosely on the core assembly.

22. Flexible power cable according to claim 1, characterized in that a filler is provided between the sheath and the core assembly.

23. Flexible power cable according to claim 1, characterized in that a filler is provided between the woven conductors.

24. Flexible power cable according to claim 22, characterized in that the filler is talcum.

25. Flexible power cable according to claim 22, characterized in that the filler is a plastic, which is extruded under pressure around the woven conductors.

26. Flexible power cable according to claim 1, characterized in that the sheath displays an inner sheath and an outer sheath.

27. Flexible power cable according to claim 26, characterized in that a woven material is provided between the inner sheath and the outer sheath.

28. Flexible power cable according to claim 26, characterized in that the inner sheath is made of a flexible foam.

29. Flexible power cable according to one of claim 1, characterized in that several core assemblies are combined to form one cable, where the core assemblies are woven into a braided structure.
